(19) United States
(12) Patent Application Publication
(10) Pub. No.: US 2026/0310422 A1
(43) Pub. Date: Oct. 8, 2026

(54) SELF-SUSTAINING DEEP LEARNING SOFTWARE ENVIRONMENT

(71) Applicant: SAP SE, Walldorf (DE)

(72) Inventor: Ramalingam TV, Calgary, CA (US)

(21) Appl. No.: 19/098,157

(22) Filed: Apr. 2, 2025

(51) Int. Cl. G06F 8/35

(52) U.S. Cl. CPC G06F 8/35

(57) ABSTRACT

A self-sustaining software environment is disclosed, leveraging machine learning (ML) and artificial intelligence (AI) to address software errors in real time. This technology pertains to computer systems, specifically enhancing software reliability through dynamic trail navigation. The technical problem addressed is the frequent occurrence of software errors that disrupt user experience and business operations. The solution involves a framework that constructs and navigates alternative trails for software processes, ensuring seamless operation without user interface disruption. The system employs ML models to enhance API performance and automatically correct errors by redirecting software flow to alternative trails. Principal uses comprise maintaining software usability and reliability in cloud-based solutions. The system comprises a hardware processor and a computer-readable medium storing instructions for identifying software function flows, generating a trail passage matrix, and redirecting flow based on detected errors. This approach offers a nearly bug-free software experience tailored to customer-specific needs.

### TECHNICAL FIELD

This document generally relates to computer systems. More specifically, this document relates to machine learning for a self-sustaining software environment.

### BACKGROUND

Computer software is used in almost every facet of life. Software, however, is prone to errors, bugs, and breakdowns, and with the evolution of cloud, software failures can be even harder to address.

### BRIEF DESCRIPTION OF THE DRAWINGS

The present disclosure is illustrated by way of example and not limitation in the figures of the accompanying drawings, in which like references indicate similar elements.

FIG. 1 is a diagram illustrating a software process comprising multiple trails, according to some examples.

FIG. 2 is a diagram illustrating trails through multiple software processes, according to some examples.

FIG. 3 is a block diagram illustrating a system for handling errors in software processes, according to some examples.

FIG. 4 is a block diagram illustrating an artificial intelligence (AI) assembler in more detail, according to some examples.

FIG. 5 is a block diagram illustrating a software model constructor in more detail, according to some examples.

FIG. 6 is a diagram illustrating a matrix, according to some examples.

FIG. 7 is a diagram illustrating a trail passage matrix, according to some examples.

FIG. 8 is a diagram illustrating another version of the trail passage matrix, according to some examples.

FIG. 9 is a block diagram illustrating a synchronous federative suite in more detail, according to some examples.

FIG. 10 is a flow diagram illustrating a method for creating a self-sustaining software environment, according to some examples.

FIG. 11 is a block diagram illustrating a software architecture, according to some examples.

FIG. 12 is a diagrammatic representation of a machine in the form of a computer system, according to some examples.

### DETAILED DESCRIPTION

The description that follows discusses illustrative systems, methods, techniques, instruction sequences, and computing machine program products. In the following description, for purposes of explanation, numerous specific details are set forth to provide an understanding of various example embodiments of the present subject matter. It will be evident, however, to those skilled in the art, that various example embodiments of the present subject matter may be practiced without these specific details.

In the rapidly evolving landscape of software development, ensuring the delivery of high-quality, bug-free software remains a significant challenge. As software systems become increasingly complex and the pace of deployment accelerates, particularly with the advent of cloud-based solutions, the occurrence of errors, bugs, and breakdowns is a common issue. These problems not only disrupt user experience but also adversely affect business operations, product reputation, and brand value. Traditional methods of software testing and quality assurance are often resource-intensive and time-consuming, leading to delays in addressing user-reported issues and potentially resulting in customer dissatisfaction and attrition.

Existing solutions lack an intelligent framework capable of dynamically adapting to and resolving software issues in real time, without impacting the user interface or experience. Current approaches often require substantial manual intervention and are unable to provide a seamless, intuitive user experience. This gap highlights the need for a more sophisticated, automated system that can preemptively address software errors, ensuring a high level of customer satisfaction and maintaining software usability and reliability.

In an example embodiment, a software framework is provided that utilizes machine learning (ML) and artificial intelligence (AI) to establish a self-mendable software environment. This framework dynamically constructs and navigates “trails” for business processes, ensuring a seamless user experience without interface disruption. The system employs ML models to enhance API performance and address software issues in real time. It comprises a sparse code suite that supports various efficiencies and promotes bug-free software operation. The framework is tailored to meet customer-specific needs, offering a nearly bug-free software experience.

More specifically, in an example embodiment, a software framework is provided that is able to automatically determine alternative trails of software flow. More specifically, each software process can be represented as a series of software functions. The path or paths that a software process takes through these software functions may be termed a “trail.” Typically a software application comprises many such trails, and which trail a software process follows depends on the specific scenario the software process is attempting to address (based on, for example, user input, contextual information about the operation of the software process, etc.).

The techniques described herein can be applied in such a way that the administrator or author of the application itself (or whoever else would ordinarily be in charge of correcting errors encountered in the application) need not even be aware that the framework has avoided or corrected the error.

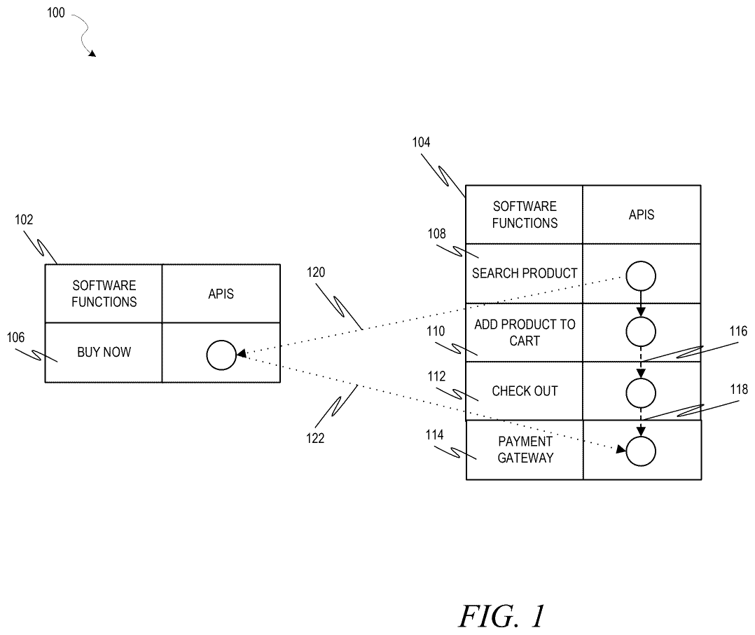

FIG. 1 is an example of a software process 100 comprising a first trail 102 and a second trail 104, in accordance with an example embodiment. Here, the software process 100 involves “checking out” of an online marketplace, wherein a user is attempting to purchase one or more products or services from the online marketplace. Here, there are two ways a user is able to check out. First, the user can simply select a “buy now” button on a user interface screen showing a product that the user wishes to purchase. This allows the user to immediately check out with the selected product. Second, the user can add products to a shopping cart while navigating the online marketplace, and then may check out to purchase all of the items in the shopping cart at once. Here, which trail is chosen to be executed is determined based on the user selections (if the user selects the “buy now” button, the first trail 102 is taken, whereas if the user selects the “check out with shopping cart” button, the second trail 104 is taken). It is not always the case that the trail selection is based solely on user input, or even based on user input at all, but in this example it is.

The first trail 102 comprises a single software function 106 which, when executed, completes the first trail 102. The second trail 104 comprises a search product software function 108, an add product to cart software function 110, a check out function 112, and a payment gateway function 114. The second trail 104 involves flowing through these software functions until they are all completed.

Assume, however, that there is a problem that is encountered such that the second trail 104 is not able to proceed to the check out function 112. This could be due to a bug within the check out function 112 itself, or with the path between the add product to cart software function 110 and the check out function 112. This problem is represented by the dashed lines of paths 116, 118, indicating that, due to the bug or other problem encountered, paths 116 and 118 are unable to be followed.

The provided software framework is able to determine that the functionality performed by the add product to cart function 110 and the check out function 112 of the second trail 104 is substantially similar to the functionality performed by the single software function 106 of the first trail 102. As such, the provided software framework dynamically creates a new trail that proceeds from the search product software function 108 of the second trail 104 to the single software function 106 of the first trail 102 and then to the payment gateway function 114 of the second trail 104, via paths 120, 122. This reroutes the software process to avoid the functions or trails in which the bug arises.

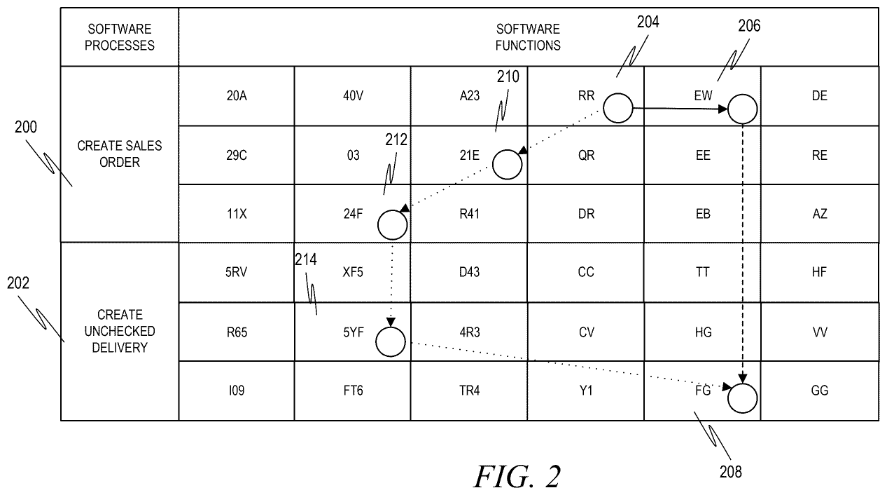

FIG. 2 is a diagram illustrating an example of trails through multiple software processes. Here, there is a first software process 200 for creating a sales order and a second software process 202 for creating an unchecked delivery. Each of these processes may comprise multiple functions. Here, the diagram illustrates an example of a specific scenario and how the flow occurs between functions of the first software process 200 and second software process 202. More specifically, the original code has a flow from the RR function 204 of the first software process 200 to the EW function 206 of the first software process 200, and then from the EW function 206 of the first software process 200 to the FG function 208 of the second software process 202. This is considered to be the main trail. As will be described in more detail below, techniques may be implemented for a system to automatically learn alternative trails to the main trail, in case one or more segments of the main trail fails due to some error. Here, for example, an alternative trail is detected from the EW function 206 of the first software process 200 to the 21E function 210 of the first software process 200 to the 24F function 212 of the first software process 200 to the 5YF function 214 of the second software process 202 to the FG function 208 of the second software process 202.

This framework is able to dynamically follow the alternative trail through the software process without the user being impacted by the change, and even without the user being aware. This is because the recursive passage of the trails occurs fluidly and the switch between the trails happens seamlessly, without altering the user interface.

In some example embodiments, the identification of alternative trails is performed in the background prior to a user encountering an issue with one of the functions. For example, the processes described herein could be performed periodically (e.g., daily) to evaluate all functions in software processes and to identify all possible trails through those processes.

In a further example embodiment, another machine learning framework is provided that automatically corrects the error in the original software function in which the error occurred.

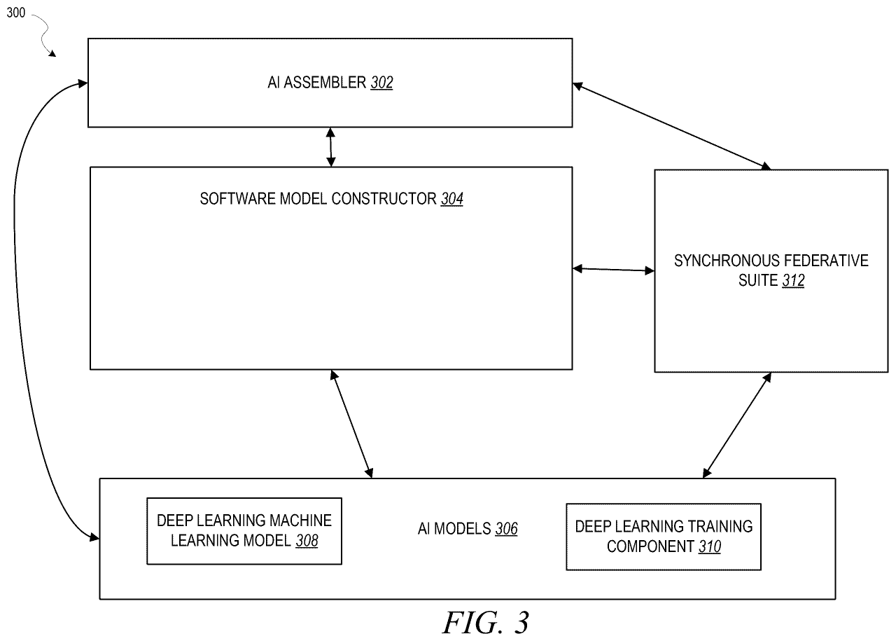

FIG. 3 is a block diagram illustrating a system 300 for handling errors in one or more functions of a software process, in accordance with an example embodiment. An artificial intelligence (AI) assembler 302 acts to take input about software functions from various sources and to construct a simulation of the software functions. A software model constructor 304 analyzes all the pieces of software available for analysis, based on the results of the simulation. and constructs a unified holistic model of the functions of these pieces of software. This includes understanding which alternative trails of functions may be available for a particular piece of software if an error occurs, as well as automatically correcting code causing an error. This is performed with the help of AI models 306, including a deep learning machine learning model 308 and a deep learning training component 310, which itself may also be a machine learning model. A synchronous federative suite 312 then acts to keep track of the various software environments and ensure that every environment is being monitored by the deep learning machine learning model 308.

The software model constructor 304, synchronous federative suite 312, and deep learning machine learning model 308 interact recursively to identify trails and potential errors and to handle such errors.

A deep learning model refers to a computational framework designed to analyze and interpret complex data through multiple layers of interconnected processing units, called neurons, which are inspired by the structure of the human brain. Deep learning models utilize a network of algorithms that work together to recognize patterns in data and make predictions or classifications based on that data.

At the core of deep learning models is the neural network structure. This structure is composed of layers of neurons, each performing a series of mathematical functions. The depth of the network is determined by the number of layers between the input and the output. The input layer receives data, and subsequent hidden layers transform and process this data through weighted connections, with each layer learning different aspects of the input information. The output layer produces the final result or decision, which can be a prediction, classification, or another form of output depending on the task.

Each neuron within the network performs a mathematical operation on the inputs it receives. The result is passed through an activation function, which introduces nonlinearity into the model, enabling it to capture and represent complex patterns in the data. These activations allow the model to adapt to and learn from data that is not strictly linear in nature.

The training process of a deep learning model involves adjusting the weights of connections between neurons through a method known as backpropagation. This process uses an optimization technique, such as gradient descent, to iteratively minimize the error between the model's predictions and the actual outcomes. Over time, this optimization leads to a model capable of making highly accurate predictions or classifications on new, unseen data.

Deep learning models can be employed in a wide range of tasks depending on the specific architecture of the model. For example, Convolutional Neural Networks (CNNs) are specialized for analyzing visual data, such as images or video, by identifying spatial hierarchies and patterns in pixel data. Recurrent Neural Networks (RNNs), on the other hand, are designed to process sequential data, such as time series or natural language, by maintaining internal states that capture information about previous inputs. Other architectures like Generative Adversarial Networks (GANs) are used to generate synthetic data that mimics a given dataset, which has applications in image generation and enhancement. Additionally, transformer-based architectures are widely applied in natural language processing tasks, enabling models to understand and generate human language effectively.

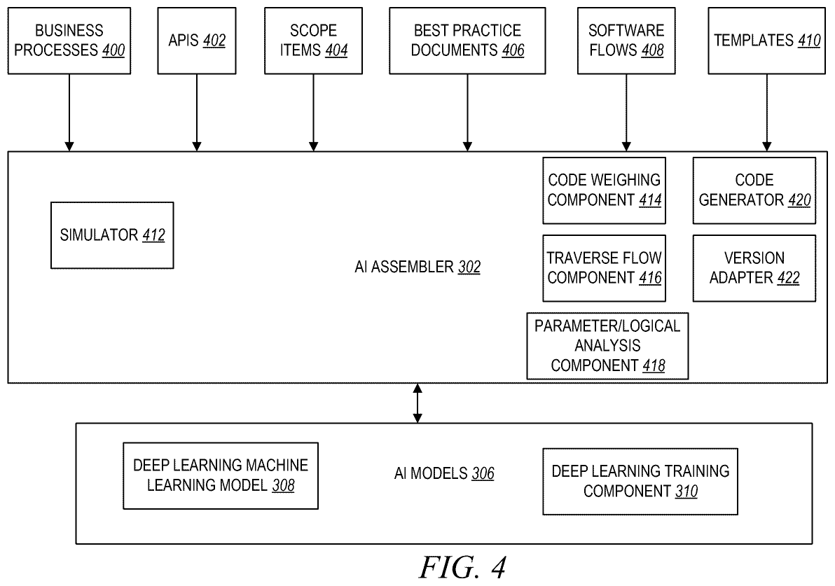

FIG. 4 is a block diagram illustrating the AI assembler 302 of FIG. 3 in more detail, in accordance with an example embodiment. Input to the AI assembler 302 includes business processes 400, Application Program Interfaces (APIs) 402, scope items 404, best practice documents 406, software flows 408, and/or templates 410. A business process is a series of structured activities or tasks that are performed by individuals or systems to achieve a specific organizational goal. These processes are designed to produce a product or service for customers and often involve multiple steps, such as planning, execution, monitoring, and optimization, to ensure efficiency and effectiveness in achieving business objectives. In the context of software, business processes can be automated and managed through various applications and systems to enhance productivity and streamline operations.

An API is a set of rules and protocols that allows different software applications to communicate with each other. It defines the methods and data formats that applications can use to request and exchange information, enabling integration and interaction between different systems or components.

A scope item is an individual unit of an API, such as an instantiation of an API or an underlying object within an API. Each scope item is responsible for performing some action related to the API. Each scope item can also be responsible for influencing output of an API.

A best practice document is a formalized guide that outlines the most efficient and effective methods or techniques for achieving a specific task or process within an organization or industry. It is based on research, experience, and expert consensus, and serves as a benchmark for performance, helping to ensure consistency, quality, and compliance with industry standards. These documents are often used to improve operational efficiency, reduce errors, and enhance overall productivity.

“Software flow” refers to the sequence or path that a software process follows as it executes various functions or operations within a software application. It involves the logical progression of tasks, decisions, and actions that occur as the software responds to inputs and processes data, often represented as a series of interconnected steps or modules that guide the software's behavior and outcomes.

A template in the context of software and computer systems is a pre-designed framework or structure that serves as a starting point for creating new documents, files, or systems. It provides a consistent format and layout, allowing users to input specific data or content while maintaining a uniform appearance or functionality. Templates are commonly used to streamline processes, ensure consistency, and save time by eliminating the need to recreate common structures from scratch.

A simulator 412 takes these input materials and uses them to simulate operation of one or more software processes. This is performed using the deep learning machine learning model 308, which is trained to perform what is called cogitation. Cogitation in this context refers to the process of deep thinking or contemplation, often involving the simulation or analysis of complex data to derive insights or solutions. It involves the use of advanced algorithms to process and interpret information, enabling systems to make decisions or predictions based on the analyzed data.

Here the cogitation involves emulating how a human creates and tests software programs. This includes creating break points in the software programs, debugging the software programs, understanding what the problems are with the software programs, etc.

The simulator 412 may work alongside a series of components used to augment the simulation process. This includes a code weighing component 414, which acts to weight which pieces of code are executed more often. A traverse flow component 416 acts to traverse all the combinations of different paths through a software flow. A parameter/logical analysis component 418 analyzes each and every parameter of each and every software function, separately. This helps to handle cases where there is a similar name for separate parameters across different programs. The same is true for values of the parameters. For example, a variable such as “max” may be used to define the maximum value for a particular variable. This maximum value, however, may be different from program to program. Indeed, it may not even represent the same “type” of thing. “Max” in one program could refer to the maximum purchase price allowable without secondary authorization, whereas “Max” in another program could refer to the maximum length of time in which an ordered product may be received. Analyzing each parameter independently helps prevent confusion in the analysis due to such similar-named parameters.

A code generator 420 generates replacement code so it may be pushed for software updates. A version adapter 422 updates the analysis when new software versions are released.

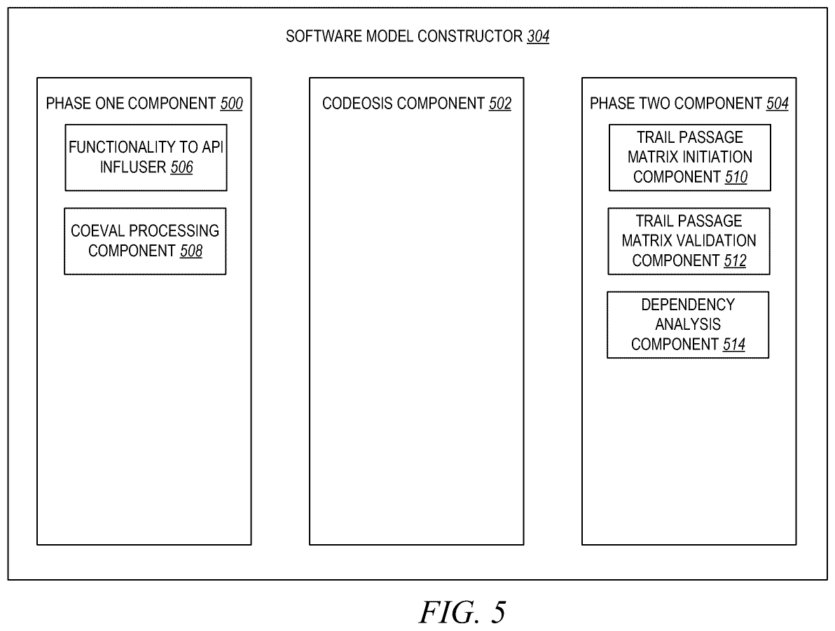

FIG. 5 is a block diagram illustrating the software model constructor 304 of FIG. 3 in more detail, in accordance with an example embodiment. The software model constructor 304 comprises three components. These include a phase one component 500, a codeosis component 502, and a phase two component 504. Each of these components may itself be a machine learning model. The phase one component 500 acts to learn what each software function does. The codeosis component 502 acts to determine how to fix or remediate issues (on the main trail through each software process). The phase two component 504 acts to learn to distinguish the alternative trail from the main trail through the software processes.

The phase one component 500 acts to create the environment used for the codeosis component 502 to understand how each function in each software process works. A functionality to API infuser 506 acts to relate the functionality of a software process to each API corresponding to the software process. The APIs are collected and processed by a coeval processing component 508. Coeval processing refers to the simultaneous or concurrent handling of multiple processes or tasks within a system. In the context of software and computing, it involves the parallel execution of operations to improve efficiency and performance. This approach allows different components or modules to work together in real time, sharing data and resources to achieve a common goal. In this context, the coeval processing component 508 is able to understand if there are any changes in the APIs or data calls, or other exchanges within the software processes.

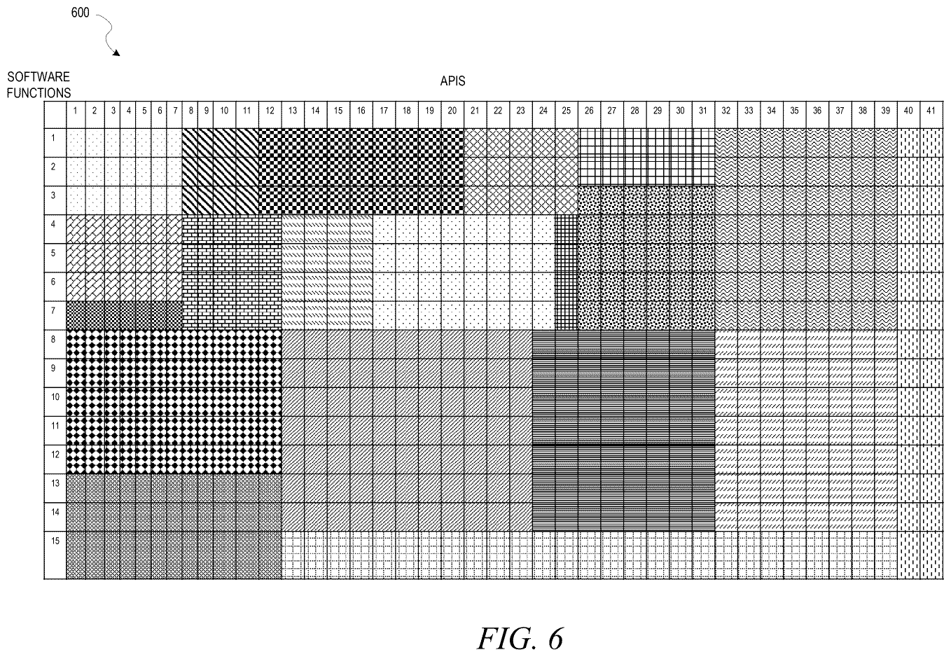

The phase one component 500 acts to convert functional flows and information about APIs into an understanding of the relationships among them and their corresponding functions. While this understanding is not yet represented in a matrix (the matrix representation will come later in the phase two component 504). It may be thought of as a rudimentary version of matrix. FIG. 6 is a diagram illustrating such a matrix, in accordance with an example embodiment. Here, software functions are represented by rows and APIs are represented by columns. The different fill patterns in the cells of the matrix correspond to an understanding of relationships between corresponding software functions and corresponding APIs. Thus, for example, the software functions labeled 1, 2, and 3 have a relationship with the APIs labeled 1, 2, 3, 4, 5, 6, and 7, and thus the fill pattern depicted in these corresponding cells is identical, and yet different than the fill patterns for other cells

Each API may be just a single step within a larger software function.

The codeosis component 502 generates code to enhance the matrix. At this stage this may involve generating new APIs for software functions.

The codeosis component 502 creates an environment for the system to create alternative code and transform or remediate any issues in any programs that it has identified an error within. First the codeosis component 502 acts to understand what the error is. The codeosis component 502, however, does not fix the issue directly. Instead, based on the information provided by the other components, it is able to understand a broad perspective, specifically which connections each program has with other processes and the flows among those connections. The codeosis component 502 therefore relies on a completed trail passage matrix, constructed by the phase two component 504, to understand these connections.

The phase two component 504 acts to generate alternative trails for the software functions. More specifically, a trail passage matrix initiation component 510 acts to generate a matrix of different trails through the software processes. A trail passage matrix validation component 512 acts to validate the generated trail passage matrix. A dependency analysis component 514 analyzes dependencies among the functions and updates the trail passage matrix accordingly.

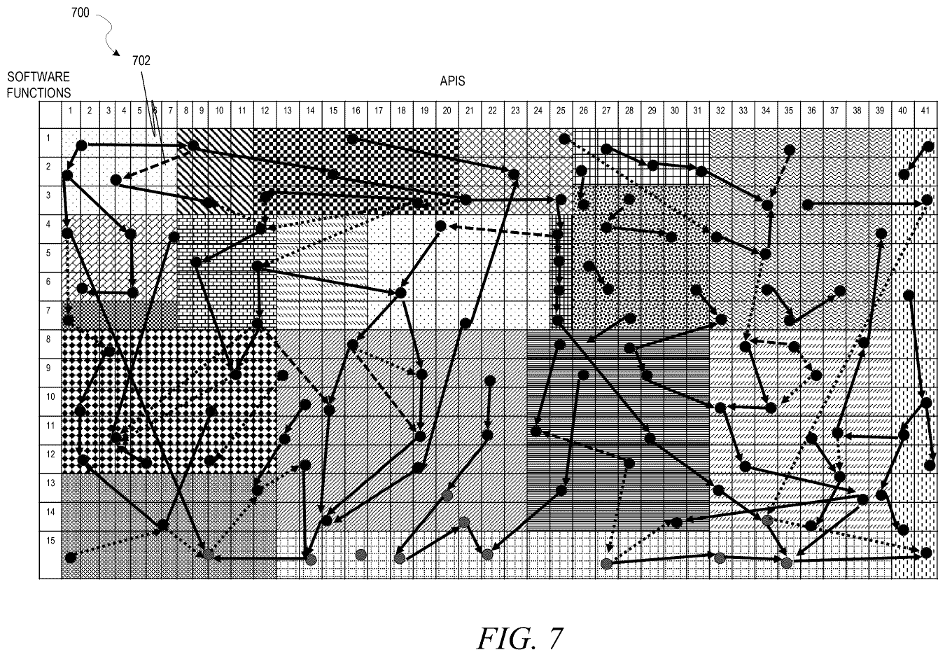

FIG. 7 is a diagram illustrating a trial passage matrix 700, in accordance with an example embodiment. Here, there are a number of different APIs, each represented by a different column in the trial passage matrix 700. There are also a number of different software processes, each represented by a different row in the trial passage matrix 700. If a dot appears in a cell of the trial passage matrix 700, this indicates that the corresponding software process from the row of the cell runs the corresponding API from the column of the cell.

The phase two component 504 acts to understand alternative trails to the main trails. In FIG. 7 this means that the phase two component 504 is acting to understand where the alternative trails should be placed (alternative trails here are indicated by dotted lines, such as line 702). The phase two component 504 actually constructs the trial passage matrix 700.

The codeosis component 502 then acts to detect errors in the software flow and corresponds those errors to broken links. This turns one or more of the main trails into a broken trail, where at least one segment is considered broken and cannot be followed. For example, the codeosis component 502 may determine that line 606 is now broken, because some functionality along or after this line is causing an error. Based on this information, the codeosis component 502 can determine whether it can correct the error directly, such as by fixing the software process that is causing the error, or whether it should bypass the broken segment by following one of the alternative trails. The result is a system that is able to automatically and seamlessly correct or remediate errors in the software processes of a software application.

The codeosis component 502 may itself be, or at least work with, a deep learning neural network as described previously. The codeosis component 502, upon determining the need for use of an alternative trail around an error, can generate corresponding code for the corresponding software function(s) to perform the operations required to follow that alternative trail, such as by altering API and function calls.

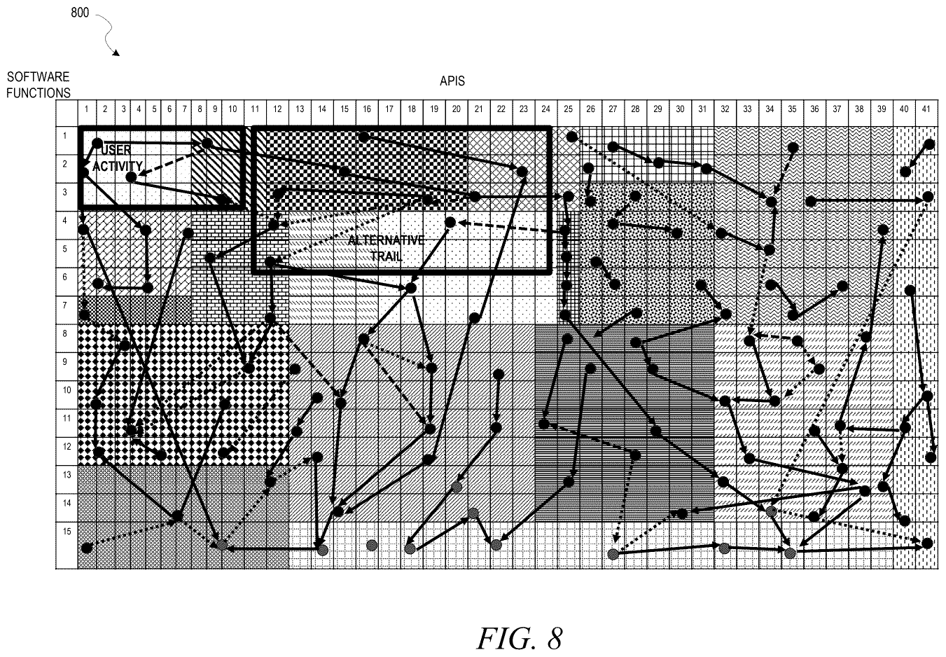

FIG. 8 is a diagram illustrating the trial passage matrix 800 after operations performed by the codeosis component 502, in accordance with an example embodiment. Here, the codeosis component 502 has identified current user activity 802 in which an error has been or will be encountered and also identified an alternative trail 804 to accomplish the same function as the current user activity 802. It may then generate the code needed to implement that alternative trail 804.

If there is no alternative trail identified, the codeosis component 502 in conjunction with the coeval processing component 508 of the phase one component 500 as well as potentially another instance of a coeval processing component contained in the phase two component 504 can actually generate such a trail, including generating new APIs, flows, and other aspects of the trail.

In summary, the described examples present a self-sustaining software environment that leverages ML and AI to address common software issues. The environment dynamically constructs and navigates trails for business processes, ensuring a seamless user experience. It employs ML models to enhance API performance and address software issues in real time. The software environment is designed to meet customer-specific needs, offering a nearly bug-free software experience.

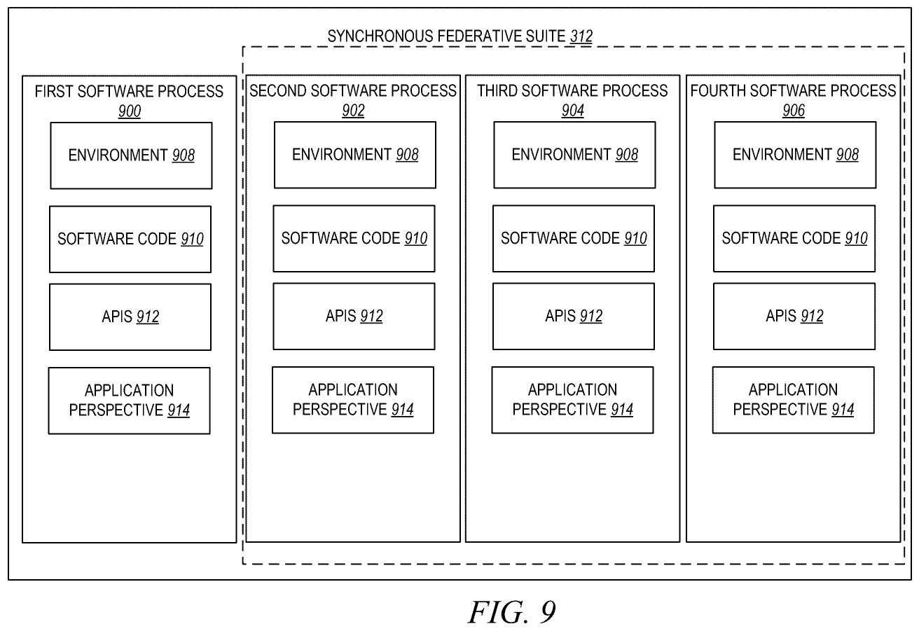

FIG. 9 is a block diagram illustrating the synchronous federative suite 312 of FIG. 3 in more detail. Here, the synchronous federative suite 312 is constantly scanning the software framework to identify any software processes within it. Here, four software processes are detected. The first software process 900 is a standalone software process, meaning that its functions do not directly interact with functions of other software processes. The second software process 902, third software process 904, and fourth software process 906 all contain one or more functions that interact with at least one other software process.

Each software process 900, 902, 904, 906 includes an environment 908, software code 910, APIs 912, and an application perspective 914.

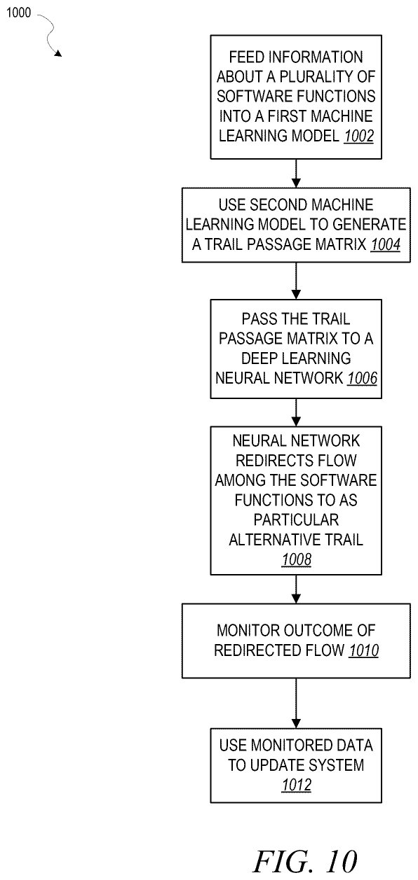

FIG. 10 is a flow diagram illustrating a method 1000 for creating a self-sustaining software environment, in accordance with an example embodiment. This method involves a series of operations that enable the dynamic construction and navigation of trails for software processes, ensuring a seamless user experience without interface disruption. While the various operations in this flowchart are presented and described sequentially, one of ordinary skill will appreciate that some or all of the operations may be executed in a different order, be combined or omitted, or be executed in parallel.

At operation 1002, the method 1000 begins by feeding information about a plurality of software functions of a software process into a first machine learning model. This model is designed to identify the flow among the software functions based on a simulation of the software process. In some examples, the information may include data from application program interfaces (APIs), best practice documents, and other relevant sources.

From operation 1002, the method 1000 flows to operation 1004, where a second machine learning model is used to generate a trail passage matrix. This matrix includes all software functions of the software process and identifies the main trail as well as one or more alternative trails. The trail passage matrix serves as a comprehensive map of potential paths that the software process can take.

At operation 1006, the method 1000 involves passing the trail passage matrix to a deep learning neural network. This network is trained to identify errors occurring during execution time within the main trail of the software process. In some examples, the neural network may utilize historical error data and predictive algorithms to enhance its accuracy in detecting errors.

From operation 1006, the method 1000 flows to operation 1008, where the neural network, based on the identified error, redirects the flow among the software functions to a particular alternative trail. This redirection ensures that the software process continues to operate smoothly despite the presence of errors. In some examples, the redirection may involve evaluating the efficiency of alternative trails and selecting the most suitable path.

At operation 1010, the method 1000 monitors the outcome of the redirected flow. This monitoring involves tracking the performance of the software process to ensure that the alternative trail achieves the desired result. In some examples, monitoring may include collecting feedback, measuring performance metrics, or detecting any anomalies that may require further action.

From operation 1010, the method 1000 flows to operation 1012, where the monitored data is used to update the system. This update involves refining the rules, models, or processes based on the feedback and performance data collected during monitoring. In some examples, the update may involve retraining machine learning models, adjusting parameters, or modifying decision criteria to improve future responses.

The method 1000 concludes after operation 1012, having processed the software functions and executed a series of operations to handle errors effectively. The flowchart provides a structured approach to managing software processes, ensuring that each operation contributes to the overall process. The transitions between operations are designed to facilitate a logical progression, allowing the system to adapt and respond to varying inputs dynamically.

It should be noted that while the above disclosure discusses several different machine learning models as separate models, one of ordinary skill in the art will recognize that any combination of these machine learning models may be combined with one another while still accomplishing all the same functionality. For example, the first machine learning model and the second machine learning model could be combined into a single model.

In view of the disclosure above, various examples are set forth below. It should be noted that one or more features of an example, taken in isolation or combination, should be considered within the disclosure of this application.

Example 1 is a system comprising: at least one hardware processor; and a computer-readable medium storing instructions that, when executed by the at least one hardware processor, cause the at least one hardware processor to perform operations comprising: feeding information about a plurality of software functions of a software process into a first machine learning model, the first machine learning model designed to identify flow among the software functions based on a simulation of the software process, the flow comprising a main trail corresponding to a first scenario; using a second machine learning model to generate a trail passage matrix, the trail passage matrix comprising all software functions of the software process and identifying the main trail as well as one or more alternative trails corresponding to the first scenario, through software functions of the software process; and passing the trail passage matrix to a deep learning neural network trained to identify an error occurring during execution time within the main trail of the software process and, based on the error, to redirect flow among the software functions to a particular alternative trail of the one or more alternative trails.

In Example 2, the subject matter of Example 1 includes, wherein the information about the plurality of software functions comprises information about one or more application program interfaces (APIs) used by the software functions.

In Example 3, the subject matter of Examples 1-2 includes, wherein the information about the plurality of software functions comprises at least one best practices document.

In Example 4, the subject matter of Examples 1-3 includes, wherein the main trail traverses software functions entirely within a single software process.

In Example 5, the subject matter of Example 4 includes, wherein the particular alternative trail traverses software functions that are contained among multiple software processes.

In Example 6, the subject matter of Example 5 includes, wherein the operations further comprise analyzing each parameter of each software function within each software process separately to ensure that parameters sharing a same name among multiple software processes are treated separately from one another.

In Example 7, the subject matter of Examples 1-6 includes, wherein the deep learning neural network is further trained to automatically fix the error by altering code of one or more software processes along the main trail.

In Example 8, the subject matter of Examples 1-7 includes, wherein the operations further comprise, in response to a determination that there are no alternative trails for the main trail, automatically generating an alternative trail.

Example 9 is a method comprising: feeding information about a plurality of software functions of a software process into a first machine learning model, the first machine learning model designed to identify flow among the software functions based on a simulation of the software process, the flow comprising a main trail corresponding to a first scenario; using a second machine learning model to generate a trail passage matrix, the trail passage matrix comprising all software functions of the software process and identifying the main trail as well as one or more alternative trails corresponding to the first scenario, through software functions of the software process; and passing the trail passage matrix to a deep learning neural network trained to identify an error occurring during execution time within the main trail of the software process and, based on the error, to redirect flow among the software functions to a particular alternative trail of the one or more alternative trails.

In Example 10, the subject matter of Example 9 includes, wherein the information about the plurality of software functions comprises information about one or more application program interfaces (APIs) used by the software functions.

In Example 11, the subject matter of Examples 9-10 includes, wherein the information about the plurality of software functions comprises at least one best practices document.

In Example 12, the subject matter of Examples 9-11 includes, wherein the main trail traverses software functions entirely within a single software process.

In Example 13, the subject matter of Example 12 includes, wherein the particular alternative trail traverses software functions that are contained among multiple software processes.

In Example 14, the subject matter of Example 13 includes, analyzing each parameter of each software function within each software process separately to ensure that parameters sharing a same name among multiple software processes are treated separately from one another.

In Example 15, the subject matter of Examples 9-14 includes, wherein the deep learning neural network is further trained to automatically fix the error by altering code of one or more software processes along the main trail.

In Example 16, the subject matter of Examples 1-15 includes, in response to a determination that there are no alternative trails for the main trail, automatically generating an alternative trail.

Example 17 is a non-transitory machine-readable medium storing instructions which, when executed by one or more processors, cause the one or more processors to perform operations comprising: feeding information about a plurality of software functions of a software process into a first machine learning model, the first machine learning model designed to identify flow among the software functions based on a simulation of the software process, the flow comprising a main trail corresponding to a first scenario; using a second machine learning model to generate a trail passage matrix, the trail passage matrix comprising all software functions of the software process and identifying the main trail as well as one or more alternative trails corresponding to the first scenario, through software functions of the software process; and passing the trail passage matrix to a deep learning neural network trained to identify an error occurring during execution time within the main trail of the software process and, based on the error, to redirect flow among the software functions to a particular alternative trail of the one or more alternative trails.

In Example 18, the subject matter of Example 17 includes, wherein the information about the plurality of software functions comprises information about one or more application program interfaces (APIs) used by the software functions.

In Example 19, the subject matter of Examples 17-18 includes, wherein the information about the plurality of software functions comprises at least one best practices document.

In Example 20, the subject matter of Examples 17-19 includes, wherein the main trail traverses software functions entirely within a single software process.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

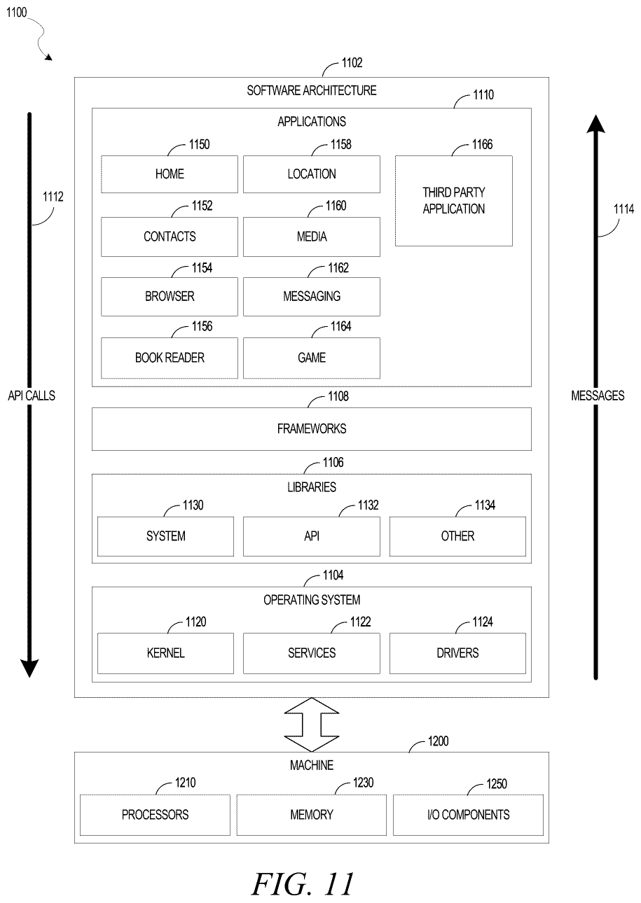

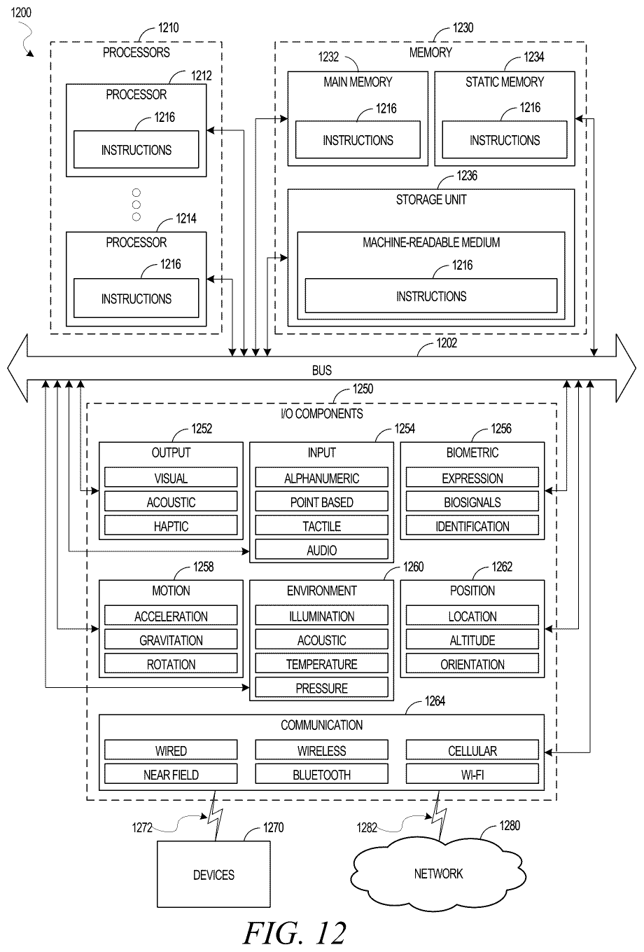

FIG. 11 is a block diagram 1100 illustrating a software architecture 1102, which can be installed on any one or more of the devices described above. FIG. 11 is merely a non-limiting example of a software architecture, and it will be appreciated that many other architectures can be implemented to facilitate the functionality described herein. In various examples, the software architecture 1102 is implemented by hardware such as a machine 1200 of FIG. 12 that comprises processors 1210, memory 1230, and input/output (I/O) components 1250. In this example architecture, the software architecture 1102 can be conceptualized as a stack of layers where each layer may provide a particular functionality. For example, the software architecture 1102 comprises layers such as an operating system 1104, libraries 1106, frameworks 1108, and applications 1110. Operationally, the applications 1110 invoke API calls 1112 through the software stack and receive messages 1114 in response to the API calls 1112, consistent with some examples.

In various implementations, the operating system 1104 manages hardware resources and provides common services. The operating system 1104 comprises, for example, a kernel 1120, services 1122, and drivers 1124. The kernel 1120 acts as an abstraction layer between the hardware and the other software layers, consistent with some examples. For example, the kernel 1120 provides memory management, processor management (e.g., scheduling), component management, networking, and security settings, among other functionalities. The services 1122 can provide other common services for the other software layers. The drivers 1124 are responsible for controlling or interfacing with the underlying hardware, according to some examples. For instance, the drivers 1124 can comprise display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some examples, the libraries 1106 provide a low-level common infrastructure utilized by the applications 1110. The libraries 1106 can comprise system libraries 1130 (e.g., C standard library) that can provide functions such as memory allocation functions, string manipulation functions, mathematic functions, and the like. In addition, the libraries 1106 can comprise API libraries 1132 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 1106 can also comprise a wide variety of other libraries 1134 to provide many other APIs to the applications 1110.

The frameworks 1108 provide a high-level common infrastructure that can be utilized by the applications 1110, according to some examples. For example, the frameworks 1108 provide various GUI functions, high-level resource management, high-level location services, and so forth. The frameworks 1108 can provide a broad spectrum of other APIs that can be utilized by the applications 1110, some of which may be specific to a particular operating system 1104 or platform.

In an example, the applications 1110 comprise a home application 1150, a contacts application 1152, a browser application 1154, a book reader application 1156, a location application 1158, a media application 1160, a messaging application 1162, a game application 1164, and a broad assortment of other applications, such as a third-party application 1166. According to some examples, the applications 1110 are programs that execute functions defined in the programs. Various programming languages can be employed to create one or more of the applications 1110, structured in a variety of manners, such as object-oriented programming languages (e.g., Objective-C, Java, or C++) or procedural programming languages (e.g., C or assembly language). In a specific example, the third-party application 1166 (e.g., an application developed using the ANDROID™ or IOS™ software development kit (SDK) by an entity other than the vendor of the platform) may be mobile software running on a mobile operating system such as IOS™, ANDROID™, WINDOWS® Phone, or another mobile operating system. In this example, the third-party application 1166 can invoke the API calls 1112 provided by the operating system 1104 to facilitate functionality described herein.

FIG. 12 illustrates a diagrammatic representation of a machine 1200 in the form of a computer system within which a set of instructions may be executed for causing the machine 1200 to perform any one or more of the methodologies discussed herein, according to an example. Specifically, FIG. 12 shows a diagrammatic representation of the machine 1200 in the example form of a computer system, within which instructions 1216 (e.g., software, a program, an application, an applet, an app, or other executable code) for causing the machine 1200 to perform any one or more of the methodologies discussed herein may be executed. For example, the instructions 1216 may cause the machine 1200 to execute the method 800 of FIG. 8, respectively. Additionally, or alternatively, the instructions 1216 may implement FIGS. 1-8 and so forth. The instructions 1216 transform the general, non-programmed machine 1200 into a particular machine 1200 programmed to carry out the described and illustrated functions in the manner described. In alternative examples, the machine 1200 operates as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1216, sequentially or otherwise, that specifies actions to be taken by the machine 1200. Further, while only a single machine 1200 is illustrated, the term “machine” shall also be taken to comprise a collection of machines 1200 that individually or jointly execute the instructions 1216 to perform any one or more of the methodologies discussed herein.

The machine 1200 may comprise processors 1210, memory 1230, and I/O components 1250, which may be configured to communicate with each other such as via a bus 1202. In an example, the processors 1210 (e.g., a central processing unit (CPU), a reduced instruction set computing (RISC) processor, a complex instruction set computing (CISC) processor, a graphics processing unit (GPU), a digital signal processor ((SP), an application-specific integrated circuit (ASIC), a radio-frequency integrated circuit (RFIC), another processor, or any suitable combination thereof) may comprise, for example, a processor 1212 and a processor 1214 that may execute the instructions 1216. The term “processor” is intended to comprise multi-core processors that may comprise two or more independent processors (sometimes referred to as “cores”) that may execute instructions 1216 contemporaneously. Although FIG. 12 shows multiple processors 1210, the machine 1200 may comprise a single processor 1212 with a single core, a single processor 1212 with multiple cores (e.g., a multi-core processor 1212), multiple processors 1212, 1214 with a single core, multiple processors 1212, 1214 with multiple cores, or any combination thereof.

The memory 1230 may comprise a main memory 1232, a static memory 1234, and a storage unit 1236, each accessible to the processors 1210 such as via the bus 1202. The main memory 1232, the static memory 1234, and the storage unit 1236 store the instructions 1216 embodying any one or more of the methodologies or functions described herein. The instructions 1216 may also reside, completely or partially, within the main memory 1232, within the static memory 1234, within the storage unit 1236, within at least one of the processors 1210 (e.g., within the processor's cache memory), or any suitable combination thereof, during execution thereof by the machine 1200.

The I/O components 1250 may comprise a wide variety of components to receive input, provide output, produce output, transmit information, exchange information, capture measurements, and so on. The specific I/O components 1250 that are comprised in a particular machine will depend on the type of machine. For example, portable machines such as mobile phones will likely comprise a touch input device or other such input mechanisms, while a headless server machine will likely not comprise such a touch input device. It will be appreciated that the I/O components 1250 may comprise many other components that are not shown in FIG. 12. The I/O components 1250 are grouped according to functionality merely for simplifying the following discussion, and the grouping is in no way limiting. In various examples, the I/O components 1250 may comprise output components 1252 and input components 1254. The output components 1252 may comprise visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1254 may comprise alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 1250 may comprise biometric components 1256, motion components 1258, environmental components 1260, or position components 1262, among a wide array of other components. For example, the biometric components 1256 may comprise components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, fingerprint identification, or electroencephalogram-based identification), and the like. The motion components 1258 may comprise acceleration sensor components (e.g., accelerometer), gravitation sensor components, rotation sensor components (e.g., gyroscope), and so forth. The environmental components 1260 may comprise, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1262 may comprise location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1250 may comprise communication components 1264 operable to couple the machine 1200 to a network 1280 or devices 1270 via a coupling 1282 and a coupling 1272, respectively. For example, the communication components 1264 may comprise a network interface component or another suitable device to interface with the network 1280. In further examples, the communication components 1264 may comprise wired communication components, wireless communication components, cellular communication components, near field communication (NFC) components, Bluetooth® components (e.g., Bluetooth® Low Energy), Wi-Fi® components, and other communication components to provide communication via other modalities. The devices 1270 may be another machine or any of a wide variety of peripheral devices (e.g., coupled via a USB).

Moreover, the communication components 1264 may detect identifiers or comprise components operable to detect identifiers. For example, the communication components 1264 may comprise radio-frequency identification (RFID) tag reader components, NFC smart tag detection components, optical reader components (e.g., an optical sensor to detect one-dimensional bar codes such as Universal Product Code (UPC) bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1264, such as location via Internet Protocol (IP) geolocation, location via Wi-Fi® signal triangulation, location via detecting an NFC beacon signal that may indicate a particular location, and so forth.

The various memories (e.g., 1230, 1232, 1234, and/or memory of the processor(s) 1210) and/or the storage unit 1236 may store one or more sets of instructions 1216 and data structures (e.g., software) embodying or utilized by any one or more of the methodologies or functions described herein. These instructions (e.g., the instructions 1216), when executed by the processor(s) 1210, cause various operations to implement the disclosed examples.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to comprise, but not be limited to, solid-state memories, and optical and magnetic media, comprising memory internal or external to processors. Specific examples of machine-storage media, computer-storage media, and/or device-storage media comprise non-volatile memory, comprising by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various examples, one or more portions of the network 1280 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1280 or a portion of the network 1280 may comprise a wireless or cellular network, and the coupling 1282 may be a Code Division Multiple Access (CDMA) connection, a Global System for Mobile communications (GSM) connection, or another type of cellular or wireless coupling. In this example, the coupling 1282 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) comprising 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 1216 may be transmitted or received over the network 1280 using a transmission medium via a network interface device (e.g., a network interface component comprised in the communication components 1264) and utilizing any one of a number of well-known transfer protocols (e.g., HTTP). Similarly, the instructions 1216 may be transmitted or received using a transmission medium via the coupling 1272 (e.g., a peer-to-peer coupling) to the devices 1270. The terms “transmission medium” and “signal medium” mean the same thing and may be used interchangeably in this disclosure. The terms “transmission medium” and “signal medium” shall be taken to comprise any intangible medium that is capable of storing, encoding, or carrying the instructions 1216 for execution by the machine 1200, and comprise digital or analog communication signals or other intangible media to facilitate communication of such software. Hence, the terms “transmission medium” and “signal medium” shall be taken to comprise any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to comprise both machine-storage media and transmission media. Thus, the terms comprise both storage devices/media and carrier waves/modulated data signals.

What is claimed is:

1. A system comprising:
at least one hardware processor; and
a computer-readable medium storing instructions that, when executed by the at least one hardware processor, cause the at least one hardware processor to perform operations comprising:
feeding information about a plurality of software functions of a software process into a first machine learning model, the first machine learning model designed to identify flow among the software functions based on a simulation of the software process, the flow comprising a main trail corresponding to a first scenario;
using a second machine learning model to generate a trail passage matrix, the trail passage matrix comprising all software functions of the software process and identifying the main trail as well as one or more alternative trails corresponding to the first scenario, through software functions of the software process; and
passing the trail passage matrix to a deep learning neural network trained to identify an error occurring during execution time within the main trail of the software process and, based on the error, to redirect flow among the software functions to a particular alternative trail of the one or more alternative trails.

2. The system of claim 1, wherein the information about the plurality of software functions comprises information about one or more application program interfaces (APIs) used by the software functions.

3. The system of claim 1, wherein the information about the plurality of software functions comprises at least one best practices document.

4. The system of claim 1, wherein the main trail traverses software functions entirely within a single software process.

5. The system of claim 4, wherein the particular alternative trail traverses software functions that are contained among multiple software processes.

6. The system of claim 5, wherein the operations further comprise analyzing each parameter of each software function within each software process separately to ensure that parameters sharing a same name among multiple software processes are treated separately from one another.

7. The system of claim 1, wherein the deep learning neural network is further trained to automatically fix the error by altering code of one or more software processes along the main trail.

8. The system of claim 1, wherein the operations further comprise, in response to a determination that there are no alternative trails for the main trail, automatically generating an alternative trail.

9. A method comprising:
feeding information about a plurality of software functions of a software process into a first machine learning model, the first machine learning model designed to identify flow among the software functions based on a simulation of the software process, the flow comprising a main trail corresponding to a first scenario;
using a second machine learning model to generate a trail passage matrix, the trail passage matrix comprising all software functions of the software process and identifying the main trail as well as one or more alternative trails corresponding to the first scenario, through software functions of the software process; and
passing the trail passage matrix to a deep learning neural network trained to identify an error occurring during execution time within the main trail of the software process and, based on the error, to redirect flow among the software functions to a particular alternative trail of the one or more alternative trails.

10. The method of claim 9, wherein the information about the plurality of software functions comprises information about one or more application program interfaces (APIs) used by the software functions.

11. The method of claim 9, wherein the information about the plurality of software functions comprises at least one best practices document.

12. The method of claim 9, wherein the main trail traverses software functions entirely within a single software process.

13. The method of claim 12, wherein the particular alternative trail traverses software functions that are contained among multiple software processes.

14. The method of claim 13, further comprising analyzing each parameter of each software function within each software process separately to ensure that parameters sharing a same name among multiple software processes are treated separately from one another.

15. The method of claim 9, wherein the deep learning neural network is further trained to automatically fix the error by altering code of one or more software processes along the main trail.

16. The method of claim 9, further comprising, in response to a determination that there are no alternative trails for the main trail, automatically generating an alternative trail.

17. A non-transitory machine-readable medium storing instructions which, when executed by one or more processors, cause the one or more processors to perform operations comprising:
feeding information about a plurality of software functions of a software process into a first machine learning model, the first machine learning model designed to identify flow among the software functions based on a simulation of the software process, the flow comprising a main trail corresponding to a first scenario;
using a second machine learning model to generate a trail passage matrix, the trail passage matrix comprising all software functions of the software process and identifying the main trail as well as one or more alternative trails corresponding to the first scenario, through software functions of the software process; and
passing the trail passage matrix to a deep learning neural network trained to identify an error occurring during execution time within the main trail of the software process and, based on the error, to redirect flow among the software functions to a particular alternative trail of the one or more alternative trails.

18. The non-transitory machine-readable medium of claim 17, wherein the information about the plurality of software functions comprises information about one or more application program interfaces (APIs) used by the software functions.

19. The non-transitory machine-readable medium of claim 17, wherein the information about the plurality of software functions comprises at least one best practices document.

20. The non-transitory machine-readable medium of claim 17, wherein the main trail traverses software functions entirely within a single software process.
